(19) United States
(12) Patent Application Publication
(10) Pub. No.: US 2008/0127502 A1
(43) Pub. Date: Jun. 5, 2008

(54) Tile installation surface level gauge

(76) Inventor: Bofu Feng, Bellevue, WA (US)

Correspondence Address: Bofu Feng, 15031 Southeast 43rd Street, Bellevue, WA, 98006, US

(21) Appl. No.: 11/980,003

(22) Filed: Oct. 30, 2007

(30) Foreign Application Priority Data
Nov. 2, 2006 (CN) 200620158003.9

(51) Int. Cl. G01B 3/14; G01B 5/25

(52) U.S. Cl. 33/562; 33/533

(57) ABSTRACT

The present invention is a low-cost tile installation surface level gauge. The tile installation surface level gauge aims to fill the gap in existing tile flooring tools. The tile installation surface level gauge is used in putting all installed tiles on the same level accurately without repeated and time consuming adjustment.

The tile installation surface level gauge includes a disk, a reeling thread, a base, and a thread reel tackle. One end of the reeling thread is attached to the middle of the disk. The thread reel tackle is installed onto the base.

The process of using the tile surface level gauge is as follows: 1) once one tile is installed, slide the disk under one of the corners of the installed tile and leave the reeling thread uncovered. The installed tile covers about a quarter of the disk. 2) Install a second tile covering about a quarter of the disk and leave the reeling thread uncovered. The second tile shall align with the first installed tile. Similarly, install two other tiles with each covering about a quarter of the disk. All four installed tiles should align with each other and form a two by two grid. The buried disk is at the center of the four installed tiles. 3) Put the base onto the four installed tiles, at the center of the four installed tiles, and directly above the buried disk. 4) Attach the loose end of the reeling thread onto the thread real tackle and 5) Use the thread reel tackle to reel in the reeling thread. The disk moves toward the installed tiles once the reeling thread is tightened. A uniform thickness is formed between the base and the disk. Thus, the installed four tiles are on the same plane and the tile installation surface is level and smooth. Repeat this process for the whole tile installation to obtain a level and smooth tile installation surface.

The disk can be made of any suitable material such as plastic and metal. It can be of any symmetric shape such as circle and square.

### CROSS-REFERENCE TO RELATED APPLICATIONS

The present invention patent application was approved in the People's Republic of China on Jul. 27, 2007. The patent application number was 200620158003.9. The patent application date was Nov. 2, 2006. The Notice of Allowance and Fee Due was sent to the inventor. The patent certificate from the People's Republic of China has not been issued. See the attached Notice of Allowance and Fee Due.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

One of the important aspects in determining the quality of tile installation is whether the installed tile surface is level and smooth. That is whether the tile installation surface is on the same plane. The quality of smoothness of the installation surface affects both the esthetics and durability of the installation.

Currently, it requires both perfectly smooth and level mount surface and seasoned installation experience to obtain a smooth tile installation surface on either floors or walls. During tile installation, two steps are crucial in obtaining a smooth and level tile installation surface. The first step is to level the floor that tiles are installed on. The second step is to use a level and straight board and a leveler on top of that board to measure whether the tile installation surface is level. If the discrepancy in levelness is large, then one can gently tap installed tiles using a beater block and hammer or a rubber mallet. During both steps, people rely on experience in order to achieve desired results.

It takes repeated and time consuming adjustment for people without experience, such as do-it-yourself homeowners, to try to install all tiles on the same plane. Even with repeated adjustment, the desired result may not be achieved because the lack of tool in ensuring a uniform level among installed tiles. This is especially true for wall mounted tile installation surface where inferior work is mostly obvious.

### BRIEF SUMMARY OF THE INVENTION

The present invention is a low-cost tile installation surface level gauge. The tile installation surface level gauge aims to fill the gap in existing tile flooring tools. The tile installation surface level gauge is used in putting all installed tiles on the same level accurately without repeated and time consuming adjustment.

The tile installation surface level gauge includes a disk, a reeling thread, a base, and a thread reel tackle. One end of the reeling thread is attached to the middle of the disk. The thread reel tackle is installed onto the base.

The process of using the tile surface level gauge is as follows: 1) once one tile is installed, slide the disk under one of the corners of the installed tile and leave the reeling thread uncovered. The installed tile covers about a quarter of the disk. 2) Install a second tile covering about a quarter of the disk and leave the reeling thread uncovered. The second tile shall align with the first installed tile. Similarly, install two other tiles with each covering about a quarter of the disk. All four installed tiles should align with each other and form a two by two grid. The buried disk is at the center of the four installed tiles. 3) Put the base onto the four installed tiles, at the center of the four installed tiles, and directly above the buried disk. 4) Attach the loose end of the reeling thread onto the thread real tackle and 5) Use the thread reel tackle to reel in the reeling thread. The disk moves toward the installed tiles once the reeling thread is tightened. A uniform thickness is formed between the base and the disk. Thus, the installed four tiles are on the same plane and the tile installation surface is level and smooth. Repeat this process for the whole tile installation to obtain a level and smooth tile installation surface.

The disk can be made of any suitable material such as plastic and metal. It can be of any symmetric shape such as circle and square.

### BRIEF DESCRIPTION OF THE SEVERAL VIEWS OF THE DRAWING

FIG. 1 is a plan view of an application of the tile installation surface level gauge constructed in accordance with the present invention.

FIG. 2 is a side elevation view of the tile installation surface level constructed in accordance with the present invention.

### DETAILED DESCRIPTION OF THE INVENTION

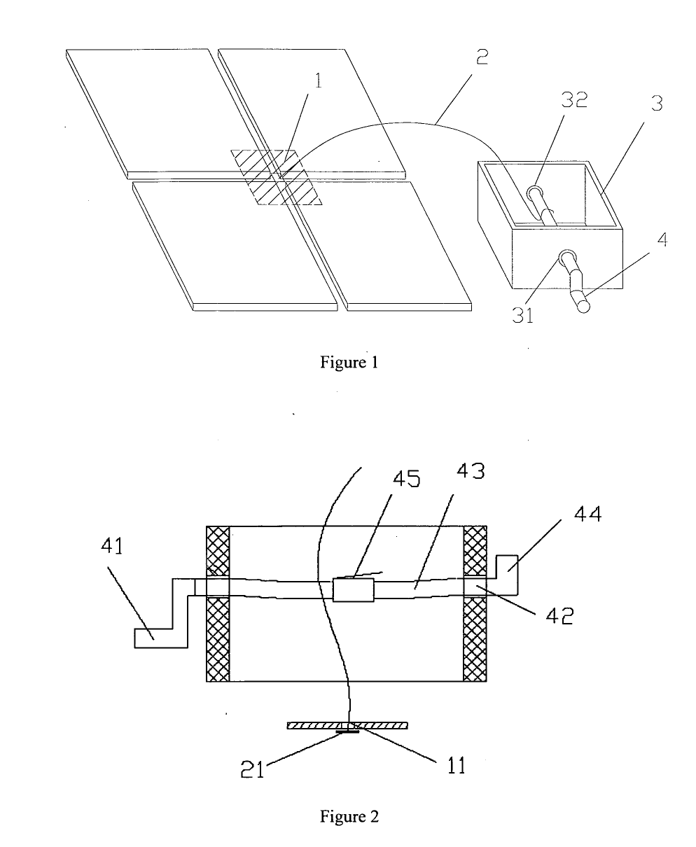

Referring now to the drawings, wherein reference numerals represent like elements, there is shown in FIGS. 1 and 2 a tile installation surface level gauge constructed in accordance with the present invention. As shown in FIG. 1, the tile installation surface level gauge includes a disk 1, a reeling thread 2, a base 3, and a thread reel tackle 4.

The disk 1 is flat and has a uniform thickness. One end of the reeling thread 2 is attached to the disk 1. The attachment can be implemented by gluing, tying, clipping, or other applicable methods. Alternatively, as shown in FIG. 2, the attachment can be implemented through attaching a chip stopper 21 bigger than a hole 11 on the disk 1 to one end of the reeling thread 2 and guide the reeling thread 2 through the hole 11 on the disk 1. The chip stopper 21 prevents the reeling thread 2 from going through the hole 11.

As shown in FIG. 1, the base 3 has two holes 31, 32 on its wall. The thread reel tackle 4 are mounted on the based 3 through the holes 31, 32. As shown in FIG. 2, the thread reel tackle 4 includes a reel handle 41, two connectors 42, a curved cross bar 43, and a bar head 44. The reel handle 41 is on the outside of the wall of the base 3. The cross bar 43 is between the two connectors 42. The cross bar 43 is not straight, which prevents the thread reel tackle 4 from turning back once the reeling thread is tightened. The loose end of the reeling thread 2 can be attached to the cross bar 43 by tying a knot. However, it is not convenient to detach the reeling thread 2 from the cross bar 43 once the tile installation surface is on the same plane. Therefore, as an alternative shown in FIG. 2, a thread holder 45 can be installed on the cross bar 43. The reeling thread can be guided on the thread holder 45. The bar head 44 prevents the thread reel tackle 4 from going off the base 3.

Once the disk 1 is buried under four installed tiles, guide the reeling thread 2 onto the thread holder 45, and turn the reel handle 41, then the reeling thread 2 goes around the cross bar 43, which tightens the reeling thread 2. With the tightening of the reeling thread 2, the cross bar 43 moves toward the installed tiles, which moves the base 3 toward the installed tiles. The base 3 presses the installed tiles evenly. Therefore, all the installed tiles are on the same plane. The elasticity and curved shape of the cross bar 43 prevent the thread reel tackle from turning backwards.

The disk 1 and reeling thread 2 may only be used once, which have to be replaced for the next installation. The disk 1 remains under installed tiles and the reeling thread 2 will be cut off. The disk 1 can be made of any material that has suitable strength, such as plastic and metal. It can be of any symmetrical shape such as circular and square. The reeling thread 2 can be made of materials with certain strength, such as cotton and polyester. The cross bar 43 can be made of metal with suitable elasticity.

The horizontal cross section of the base 3 can be of any symmetrical shape, such as circle and square. Its wall needs to have a suitable thickness to ensure that it can withstand certain pressure.

Although the invention herein has been described with references to particular embodiments, it is to be understood that the embodiments are merely illustrative of the principles and application of the present invention. It is therefore to be understood numerous modifications may be made to the embodiments and that other arrangements may be devised without departing from the spirit and scope of the present invention as defined by the claims.

1. A tile installation surface level gauge comprises of a disk, reeling thread, base, and thread reel tackle. One end of the said reeling thread is fastened onto the middle of said disk, and the said thread reel tackle is installed on the said base.

2. The tile installation surface level gauge of claim 1, wherein the said disk has a hole in the middle, one end of the said reeling thread is fastened to a chip stopper bigger than the said hole, the attachment of the said reeling thread to the said disk can be implemented by pulling one end of the said reeling thread through the said hole on the disk, the said chip stopper prevents the said reeling thread from going through the said hole.

3. The tile installation surface level gauge of claim 1 or 2, wherein the said thread reel tackle has a reel handle, two connectors, a curved cross bar, a bar head, the said reel handle is outside of the wall of the base, the said connectors correspond to the said two holes on the base wall, the said curved cross bar is between the said connectors, the said reeling thread can be attached to the said curved cross bar.

4. The tile installation surface level gauge of claim 1 or 2, wherein the horizontal cross section of the base can be of any symmetrical shape such as circle or square.

5. The tile installation surface level gauge of claim 1 or 2, wherein the said disk can be of any symmetrical shape such as circle or square.

6. The tile installation surface level gauge of claim 3, wherein the said cross bar is made of any metal, which has suitable elasticity.

7. The tile installation surface level gauge of claim 6, wherein the said cross bar has a thread holder.
